(19) United States
(12) Patent Application Publication
(10) Pub. No.: US 2003/0224807 A1
(43) Pub. Date: Dec. 4, 2003

(54) Method and apparatus for control of presentation equipment

(75) Inventors: Nikesh C. Sinha, Bokaro Steel City (IN); Arjuna Rao Chavala Venkateswarlu Chavala, Andhra Pradesh (IN)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 10/156,448

(22) Filed: May 28, 2002

(51) Int. Cl. H04Q 7/20

(52) U.S. Cl. 455/463; 455/454

(57) ABSTRACT

A presentation automation includes a wireless network interface connection between a computer of a presenter and presentation equipment including, for example, a video projector, a loud speaker system, a temperature control system for the conference room, lighting for the conference room, and optionally window shades for the conference room. The wireless communication protocol is defined by the Bluetooth wireless network, for example.

### BACKGROUND OF THE INVENTION

1. Field of the Invention

The present invention relates generally to an apparatus and method for operation and control of presentation equipment, such as conference room and meeting room equipment, in particular, using wireless network technology.

2. Description of the Related Art

Conference rooms and meeting rooms provide important focus points for today's business. During meetings in such conference rooms and meeting rooms, loudspeaker systems, overhead projectors and video projectors, projection screens, white boards, black boards, and other technical equipment are often used. Prior to conducting the meetings, extensive wiring and set up is required in order to prepare for presentations and the like. Display equipment must be set up and tested before each presentation and is taken down after the presentation. Presenters may use small computers, such as laptop or notebook-type computers which are connected to the display equipment, for example to the video projector. However, such small computers have only limited numbers and types of connections which can be made, thus limiting the type of cabling which may be utilized to connect to presentation equipment.

During a presentation, the presenter, or speaker, may have to activate microphones, operate light controls, and even close window shades. Performing these tasks, particularly in a darkened conference room, presents challenges to even the best presenters and interferes with an effective presentation. These tasks are even more difficult for disabled persons.

### SUMMARY OF THE INVENTION

A presentation system for operation and control of presentation equipment in, for example, conference rooms and meeting rooms includes a wireless network communication link between a presenter's computer and the conference room equipment used by the presenter to conduct the presentation. The presenter's computer may be a desktop, laptop or notebook computer, handheld computer, personal data assistant, portable handheld device, mobile telephone, or other electronic device. Wireless network communications are provided between, for example, the presenter's computer and the lights, projectors, sound systems, projection screens, display boards and/or window shades in the conference room, as may be necessary in the particular presentation setting, to provide control of these technical devices. In additional examples, the presenter's computer may wirelessly connect to laptop or notebook computers, mobile personal computers, handheld computers, personal data assistants, mobile telephones, or other electronic devices of attendees for the meeting.

### BRIEF DESCRIPTION OF THE DRAWINGS

FIG. 1 is a schematic illustration of a conference room showing technical equipment for use in a presentation within the conference room, the technical equipment being interconnected by wireless networking;

FIG. 2 is a flow chart showing the steps for logging a device onto the wireless network;

FIG. 3 is a diagram illustrating communication pathways between a presenter, and attendee, and a projector during a communication handover; and

FIG. 4 is a flow chart showing the steps of a communication handover as shown in FIG. 3.

### DETAILED DESCRIPTION OF THE PREFERRED EMBODIMENTS

The following detailed description of preferred embodiments illustrates the exemplary embodiments of the invention without limitation to the scope of the claims.

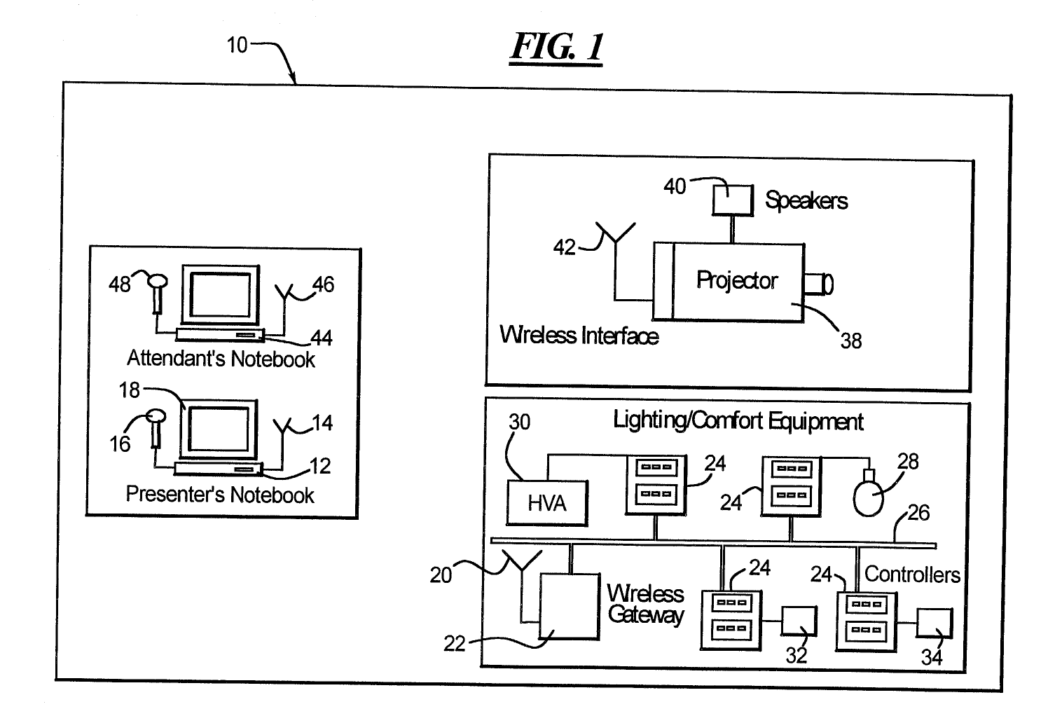

In FIG. 1, a conference room 10 is shown schematically. The present invention is applicable to conference rooms, meeting rooms, auditoriums, theaters, meeting halls, banquet halls, or any other facility or gathering place. The conference room 10 or other facility provides a location for the gathering of persons, referred to here as attendees, to hear and/or see the presentation of one or more presenters, or speakers. The presenter may wish to enhance the presentation by use of audio and/or visual materials, which may be presented on overhead projectors, slide projectors, movies projectors, video projectors, over loudspeakers and microphones, possibly using black boards or white boards, video screens, projection screens, or other equipment. The presenter may also seek to control the lights in the conference room or facility, raising or dimming the lights (or shutting them off altogether) as necessary, and may seek to control environmental aspects of the facility, including heating and/or air conditioning, and air circulation. If the conference room has windows, the presenter may wish to control the window shades as well. Screens, such as projection screens, may be raised and lowered by the presenter.

In this regard, the presenter has a computer 12, shown here as a notebook computer, although other types of computers and electronic devices are also possible. The presenter's computer 12 has a wireless network interface, indicated at 14. In one embodiment, the wireless interface 14 is provided for a notebook computer or personal computers with an external PCMCIA card interface so that the computer 12 is wireless enabled. Other types of wireless communication connections are, of course, possible and are within the scope of the present invention. A microphone 16 is also provided that is connected to the presenter's computer 12. The presenter's computer 12 includes a display 18, such as a flat screen display or a CRT (Cathode Ray Tube).

The conference room 10 has a wireless network connection 20 connected to a wireless gateway 22. The wireless gateway 22 is connected to controllers 24 over a network bus 26. The controllers 24 are connected for control of lighting, as indicated at 28, and HVAC (Heating, Ventilation, Air Conditioning equipment), as indicated at 30, for the conference room 10. A controller 24 may be provided for a remotely controlled projection screen 32 or this could be for an electronic white board, as well. A controller 24 is also provided for the window shades 34, permitting the shades to opened or closed.

As such, the presenter may control the lighting 28, heating and air conditioning equipment 30, and other equipment within the conference room or affecting the conference room through the presenter's notebook computer 12.

The conference room 10 has audio/visual equipment for use during the presentation, including a projector 38 and speakers 40. A wireless interface 42 is provided for the projector 38 and speakers 40 so that the presenter, through the presenter's notebook 12, can control the information being displayed through the projector 38 and being played through the speakers 40. Presentation software is well known for preparing and displaying audio/visual material through a video projector connected to a computer. According to the present embodiment, this presentation can now be carried out via the wireless communication link between the presenter's computer 12, on the one hand, and the projector 38 and speakers 40, on the other hand.

In addition to the equipment for facilitating the presentation and for controlling the environmental aspects of the facility, the attendees of the conference or meeting may have laptop or notebook-type computers, personal data assistants, or other electronic devices. The computers of the attendees are represented in FIG. 1 by notebook computer 44. According to an aspect of the invention, the computers 44 of the attendees are provided with wireless communication devices 46 so that the attendees may view the presentation materials on their own computers 44. The attendees may receive on their computers 44 the same data being sent to the projector 38 by the presenter, or the attendees' computers 44 may be used instead of a projector 38. The presenter may also cause the presenter's computer 12 to provide different information to the attendees' computers 44 than is being displayed with the projector 38.

The attendees' computers 44 also have microphones 48 so that the attendees can participate in the presentation. An attendee wishing to ask a question, make a statement, or show the attendees own material may do so using the wireless network communications. First, the attendee must make a request to the presenter for access to the presentation equipment, such as the speakers 40 and projector 38. The presenter may then turn over the floor, so to speak, to the attendee, who may now speak to the other attendees using the speakers 40 and the attendee's own microphone 48. This communication link by the attendee is temporary and controlled by the presenter, so that the presenter can regain control over the presentation and the technical equipment as desired.

Where reference is made herein to the presenter, this reference also includes the possibility that the computer designated as the presenter's computer may be operated by the presenter's assistants, or by members of the staff or employees of the conference center, or by other persons. The reference to the presenter's computer does not refer to ownership, but only to use or operation of the device. Likewise, references to the attendees' computers does not imply ownership but merely use for purposes of attending the conference. As such, it is anticipated that a conference center may be provided with computers for at least some of the attendees' use and even for the presenter's use. The environment and audio/visual equipment noted herein are provided as examples, and other equipment is possible and within the scope of this invention.

Thus, the time and expense of wiring conference rooms and meeting rooms for meetings, presentations and talks is avoided; the equipment needed for the presentation is connected by a wireless communication network to the computer or other device of the presenter. The wireless network is preferably a short range, low power, radio network, such as a wireless Personal-Area Network (PAN), wireless Local Area Network (LAN), or wireless UltraWideBand Network (UWB). These are provided only as examples, and other communication connections are also possible.

According to a preferred embodiment, a wireless communication system is provided to interconnect all of the devices in the conference room or meeting room using, for example, a type of Personal-Area Network (PAN) known as Bluetooth technology, or using communications according to the IEEE draft standards section 802.11a or 802.11b protocols. These use unlicenced frequency bands over relatively short distances to replace serial and USB cables. Using Bluetooth technology, a serial port profile is provided for all connections. A similar approach is provided for communications according to the section 802.11a or section 802.11b standards. Other network models may be used according to the invention, including both wireless and wired networks.

The wireless network permits properly equipped mobile electronic devices, such as portable computers, mobile phones and personal electronic devices, that enter the network coverage area to be logged onto the network. In this way, attendees entering a conference room or other meeting area with their mobile electronic devices have the mobile electronic devices logged onto the communications network while the devices are on. The mobile electronic devices of the attendees are logged on to the network in the attendee mode, permitting receipt of information transmitted by the presenter onto the attendees' mobile electronic devices.

Depending upon the services available, a wireless network is established, monitored and controlled. In a preferred embodiment, multi-speaker conferencing systems are controlled using Bluetooth enabled speaker phones and headsets.

As a further aspect, operations are automated depending upon real time events. For example, light switches are switched on and off automatically at the start and stop of the presentation. Window shades are set to close when the presentation starts, and equipment used for different parts of the presentation is set to become active at the appropriate moment. These events are programmed into the presentation software, just as the sequential display of images or playing of sounds is programmed by the presenter.

The presenter may choose to utilize special visual and/or audio effects in the presentation, and these are controlled by the presenter's computer as well. For example, special effects lighting, spot lighting, laser displays, sound effects, animated displays, robotic displays, atmospheric effects such as fog or mist machines, and other theatrical effects may be linked via the present wireless network for operation by the presenter, or by others.

Once the equipment, such as the conference room equipment and the computers, is powered on, the equipment enters services supported by the equipment in a service discovery protocol (SDP) database. All services will be entered as a universal unique identification (UUID) as specified in the Bluetooth specification 1.1.

A service entry in the SDP (service discovery protocol) database for the projector or display device is a video service (VD_service) and/or an audio service (AD_service). A service entry in the SDP database for notebook or laptop personal computers (PCs) is a conference automation service (CAUTO_service). The service entry in the SDP database for lighting and comfort equipment is light service (LGT_service) and temperature service (TEMP_service).

According to the invention, modes are defined including the mode for presenter and the mode for attendee. These modes are recognized by the master network. The presenter acts as the master of the network. Devices and services supported by the network are available to the master. The attendees do not have the ability to control the devices and services supported by the network while logged into the network in the attendee mode. Supported services are stored in a storage apparatus, such as, for example a network server or the presenter's computer, and are shared by all devices participating in the network.

The present embodiment utilizes an AD HOC network formation. Depending upon the services available on the network, connections will be made to the corresponding equipment. For example, if the projector or the video service is not available in the network, the presenter's data will be sent to all of the attendee's notebook computers 44. If a projector or a video service is available, the presenter's data will be sent to the projector 38 and in turn displayed on a large screen in the conference room. Checking of the availability of the services is done periodically. Service availability or unavailability is reported to a storage apparatus, that is for example in the network server or the presenter's computer 12, and to all of the devices in the network.

According to an aspect of the present invention, new devices may be added into the wireless network by bringing device into the proximity of the network without requiring that the network operation be halted and without interruption of the current presentation. Conversely, devices leaving the network area are logged off the network. This applies to the presentation equipment, such as the video projector, as well as to the mobile electronic devices of the attendees. It is foreseen that the coming and going of the attendees will result in more frequent logging on and logging off of attendees' computers to the network than for logging on and off of the presentation equipment.

The present invention utilizes wireless network technology, such as Bluetooth wireless technology to provide a presentation automation. The presentation automation supports transferring of a presenter's data to a projector. If a projector service is available, then the presenter, who is a participant of the conference identified as a presenter by a presenter mode, is able to send data to the projector. If the projector service is not available, then the data is sent to all of the participants in the conference. The participant who has the presenter mode set is connected as well to the lighting and temperature control devices.

In the following is described a subsystem for a presentation manager that is present within the presentation automation system. The presentation manager provides two tasks, namely network formation and data transfer. In the network formation function, the equipment is powered on and is required to enter services supported by the equipment in a service discovery protocol (SDP) database. The services are entered as universal unique identifications (UUID) as specified according to the Bluetooth specification 1.1. The services entered in the SDP database for the projector are referred to as video service and audio service. The service entry for the notebook computers is the presentation automation service while the service entry for lighting and comfort equipment is light service and temperature service.

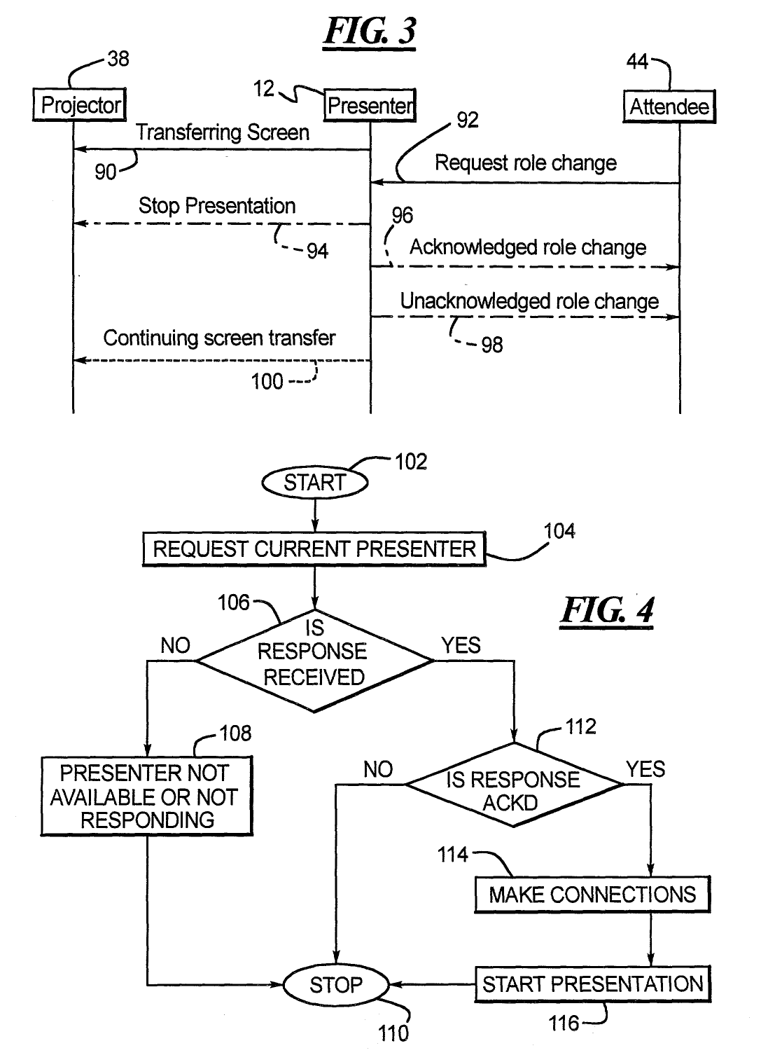

The data transfer operation of the present invention provides a module which is responsible for the smooth flow of the presentation. During the presentation, data on a presenter's laptop computer screen 18 is captured and put into a file. Later, the file is sent over the Bluetooth link, for example, to the projector or to the attendees' computers. The presentation manger is also responsible for all of the requests for a change in the role of presenter. By proper hand shaking operation, the role of presenter and attendee can be exchanged. The procedures and algorithms to be followed are shown in FIGS. 3 and 4.

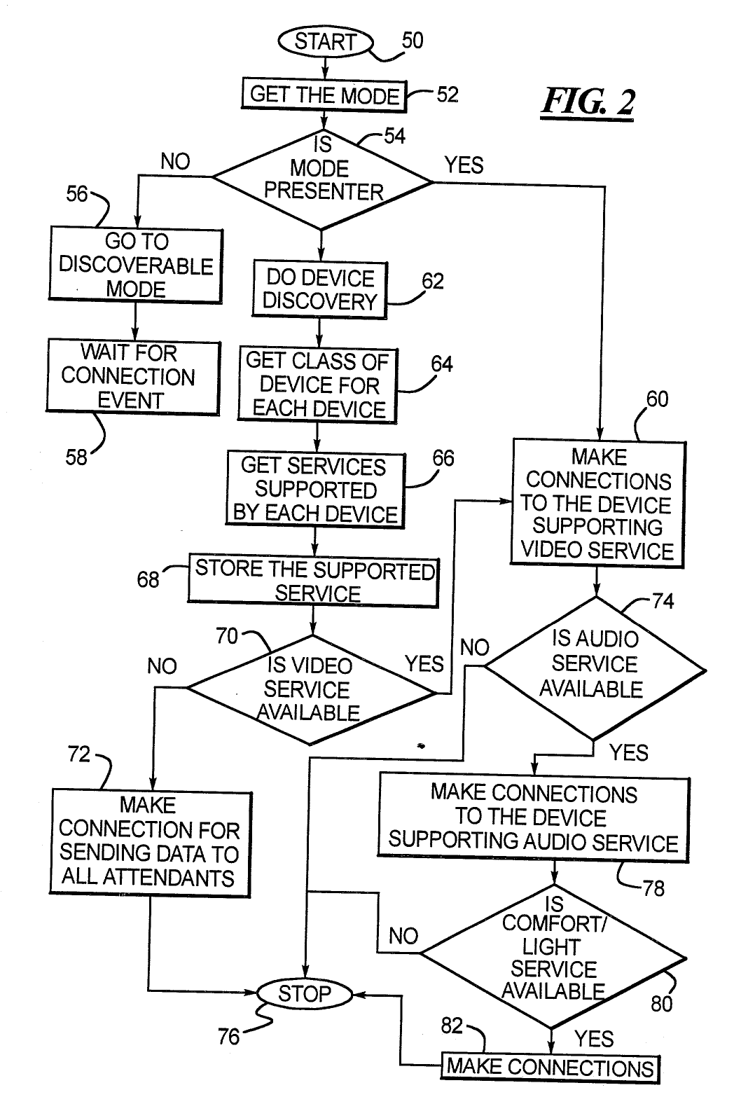

In FIG. 2, a method for determining the role of a participant at a conference begins at 50 and gets the mode of the participant, actually the mode of the participant's computer, at step 52. A determination is made at 54 as to whether the participant is a presenter. If not, the apparatus goes to a discoverable mode at 56, where it is discovered by the presenter, and waits for a connection event at 58. The participant is assigned the role of attendee, with a corresponding limitation on the control authorization that applies to that mode. If the participant has been determined at 54 to be a presenter, a discovery step is performed to determine what devices are available to the presenter's computer. The step of performing a device discovery is performed at 62 in order to discover each of the devices in the range of the presenter. That is, in the discovery mode, the presenter's computer discovers all of the devices with which it can communicate during the presentation. Then, the device class for each device is obtained at 64 and the services supported by each device is obtained at 66. The devices that have been discovered, the classes of each discovered device, and the services that these devices provide are stored in the supported services database at 68. If video services are available at 70, a connection is made to the device supporting the video service at step 60. If no video service is available, a connection is made at 72 for sending data directly to all attendees' computers 44.

Following connections to a device supporting video service at 60, an inquiry is made at 74 as to whether an audio service is available. If not, the process skips the next step. Alternately, the audio service may be transmitted to the attendees' computers. However, if an audio service is available, a connection is made at 78 to the device supporting the audio service, i.e. a loudspeaker system. Thereafter, an inquiry at 80 is made as to whether lighting and comfort control—i.e. temperature control—services are available. If they are, the connections are made at 82 to the presenter's computer. If not, however, the connection step is skipped. The process is stopped at 76, having set up the presenter's computer for operation of the presentation equipment for use by the presenter. The presentation may then begin.

Of course, these steps are shown only by way of example, and other devices and services may be added or substituted for those shown here. For example, a step to check for window shades, or electronic whiteboards, or special effects lighting, may be provided.

Referring to FIG. 3, an exchange of roles between the presenter and an attendee is illustrated. The presenter using the presenter's computer 12 is transferring data corresponding to the presenter's computer screen 18 to a projector 38 as shown at 90. An attendee of the conference makes a request via the attendee's computer 44 to the presenter, through the presenter's computer 12, for a role change as shown at 92. The presenter, through the presenter's computer 12, then issues a command to the projector 38 to stop the presentation at 94, thereafter acknowledging the role change to the attendee at 96 by sending the appropriate instruction from the presenter's computer to the attendee's computer. The attendee then is able to provide data directly to the projector 38 and the speakers 40 from the attendee's computer 44. Following the attendee's use of the projector 38, the presenter (the original presenter) un-acknowledges the role change as shown at 98, switching the presenter operation back to the original presenter whereupon the presenter continues to transfer screen data to the projector 38 as shown at 100.

The roll change is preferably only for purposes of access to the audio and/or video equipment by the attendee, but also transfers control to the attendee for the lights, temperature, window shades and the like. Such a roll change may be termed a hard roll change. Alternately, control over the lights, temperature, windows shades and like devices is retained by the presenter in what may be termed a soft roll change. Such a soft roll change involves only a hand over of control of the audio and video equipment. It is also foreseen that the temporary handover may permit the attendee and the presenter to both access the loudspeaker system so that both could be heard during a question and answer session.

In FIG. 4, the process of switching roles is illustrated in a flow chart, where following a start at 102 a request is received by the presenter at 104. A determination is made at 106 as to whether a response has been received. If no response is received, the presenter is not available or is not responding at 108 and the process is stopped at 110. On the other hand, if the response is received, an inquiry is made at 112 as to whether the response is acknowledged by the presenter. If not, the process is stopped at 110. On the other hand, if the request is acknowledged, the connections are made at 114 and the presentation by the attendee is started at 116.

The temporary handover of the presenter and attendee roles described above may be applied to wired networks as well. In that regard, many further aspects of the present invention may find utility in wired and wireless communications of various types, including mobile telephones, personal data assistants, and others.

Thus, the wireless network interface between the presenter's notebook, laptop, or other portable personal computer, to display equipment such as video projectors, overhead projectors and white boards, to audio equipment such as microphones and speakers, as well as to environmental equipment such as light controls, window blind controls, and even the thermostat control of the meeting room or conference room enables the presenter to control each of these devices through the presenter's computer without the presenter having to move around in the conference room to operate or make changes in the settings on the devices. For example, the presenter operates the presenter's computer to control the window shades to close, to dim the room lights, to lower a projection screen and to begin showing a video presentation projected by a video projector. The volume control of the sound system is adjustable by the presenter and the presenter may speak to the audience through the microphone connected to the presenter's computer. The presenter may even adjust the temperature control in the room to prevent the room from becoming too warm due to the presence of many attendees. During the question and answer part of the presentation, the presenter may raise the room lights and activate an electronic white board as an aid to understanding. An attendee of the conference may request control of the projector. This request may be acknowledged by the presenter and control of the projector may be turned over to the attendee, whereupon the roles of presenter and attendee are changed.

A single point interface is provided for monitoring and controlling all of the equipment in the conference room. This provides particular advantage for presenters working in darkened rooms and especially for disabled persons making presentations. Meetings can even be conducted utilizing video displays even where no video projectors are available, for example, by displaying video from a presenter's equipment to the notebook computers of the attendees in the meeting room.

The present invention provides utility in meeting rooms, conference rooms, conference halls, display halls, theaters, and other public gathering places.

As a further feature, a recording means may be connected to the wireless network and/or to at least one of the conference equipment devices to permit the conference proceedings to be recorded. In this way, the participation of the presenter and any attendees who are permitted access to the equipment is available for review later. Yet another aspect is that the conference proceedings may be transmitted to a remote location so that attendees in, for example, another city, may experience the presentation including the input from the attendees. This remote transmission may be over telephone lines, Internet communications, or otherwise.

Thus, there have been shown and described a method and apparatus for enabling wireless communication and setup of meeting room and conference room equipment and centralized control of the conference room through a presenter's notebook computer, for example. Attendees at the conference may temporarily take over control of display equipment, such as a video projector, following a request by the attendee of the presenter. Setup and take down of conference room equipment is thus simplified.

Although other modifications and changes may be suggested by those skilled in the art, it is the intention of the inventors to embody within the patent warranted hereon all changes and modifications as reasonably and properly come within the scope of their contribution to the art.

We claim:

1. A method for controlling conference equipment, comprising the steps of:
logging the conference equipment having a wireless networking interface on to a wireless network;
recognizing functions of the conference equipment over said wireless network; and controlling the conference equipment over said wireless network by a presenter.

2. A method as claimed in claim 1, wherein the conference equipment includes at least one of the following: lights, temperature control, window shades, loudspeaker system, and video projector.

3. A method as claimed in claim 1, wherein the conference room equipment includes attendees' computers.

4. A method as claimed in claim 1, further comprising the steps of:
automatically recognizing wireless network devices of attendees entering a conference area; and
transmitting data over said wireless network to said wireless network devices of the attendees in the conference area, said data being transmitted from a presenter's device.

5. A method as claimed in claim 1, further comprising the step of:
defining a presenter mode and an attendee mode, said presenter mode enabling control of the conference equipment and said attendee mode being disabled from controlling the conference equipment.

6. A method as claimed in claim 5, wherein said conference equipment includes presentation equipment and environmental equipment, said presenter mode enables control of both said presentation equipment and said environmental equipment.

7. A method as claimed in claim 4, further comprising the step of:
temporarily assigning control of said presentation equipment to an attendee.

8. A method as claimed in claim 7, wherein said step of temporarily assigning includes the sub-steps of:
providing a request function for temporary access to presentation equipment by an attendee so that an attendee can issue a request for temporary access,
providing an acknowledgment function of said request by the presenter so that a presenter can acknowledge said request, and
providing a temporary hand over of access of said presentation equipment to the attendee by the presenter so that the presenter can temporarily hand over access to the attendee who made the request.

9. A method as claimed in claim 8, wherein said step of temporarily assigning includes the sub-steps of:
providing a restore function to restore access to said presentation equipment to the presenter following access to said presentation equipment, said restore function being under control of the presenter.

10. An apparatus for presentation automation, comprising:
a wireless network enabled audio/visual apparatus operable for a presentation; and
a wireless network enabled computer in communication with said wireless network enabled audio/visual apparatus over a wireless network so that said wireless network enabled audio/visual apparatus operates with data sent from said wireless network enabled computer for a presentation.

11. An apparatus as claimed in claim 10, wherein said wireless network enabled audio/visual apparatus includes a wireless network enabled projector.

12. An apparatus as claimed in claim 10, wherein said wireless network enabled audio/visual apparatus includes a wireless network enabled loudspeaker system.

13. An apparatus as claimed in claim 10, further comprising:
wireless network enabled environmental controls in communication with said wireless network enabled computer so that said wireless network enabled computer can control said environmental controls.

14. An apparatus as claimed in claim 13, wherein said wireless network enabled environmental controls include a wireless network enabled lighting control and a wireless network enabled temperature control.

15. An apparatus as claimed in claim 13, wherein said wireless network enabled environmental controls include a wireless network enabled window blind.

16. An apparatus as claimed in claim 10, wherein said wireless network is a Bluetooth network.

17. An apparatus as claimed in claim 10, wherein said wireless network defines a presenter mode and an attendee mode, said wireless network enabled computer being assigned said presenter mode and enabled for communication with said wireless network enabled audio/visual apparatus, said attendee mode being characterized as disabled from communication with said wireless network enabled audio/visual apparatus and enabled to receive data from said wireless network enabled computer assigned said presenter mode.

18. A method for mode change in a presentation, comprising the steps of:
defining a presenter mode for a first computer with a communication connection;
defining an attendee mode for a second computer with a communication connection;
providing a communication connection between presentation equipment and said first computer in said presenter mode so that data from said first computer is communicated to said presentation equipment;
defining a request for mode change from said second computer in said attendee mode to said first computer in said presenter mode for access to said presentation equipment by said second computer; and
temporarily assigning said presenter mode to said second computer so that data from said second computer is communicated to said presentation equipment.

19. A method as claimed in claim 18, wherein said communication connection is a wireless connection.

20. A method as claimed in claim 18, further comprising the step of:
reassigning said attendee mode to said second computer following said step of temporarily assigning said presenter mode to said second computer.

21. A method as claimed in claim 20, wherein said step of reassigning is controlled by said first computer.

22. A method as claimed in claim 18, wherein said step of temporarily assigning said presenter mode to said second computer is controlled by said first computer.

23. A method as claimed in claim 18, wherein said step of defining an attendee mode defines said attendee mode for a plurality of second computers, and
said step of temporarily assigning said presenter mode temporarily assigns said presenter mode to any of said plurality of second computers.

24. A method as claimed in claim 18 wherein said presentation equipment includes a video projector.

25. A method as claimed in claim 18, wherein said presentation equipment includes a sound system.

26. A presentation method, comprising the steps of:
sending first information over a wireless communication network from a presenter's computer to an attendee's computer; and
sending second information from the presenter's computer to a central display device for display to the attendee.

27. A presentation method as claimed in claim 26, further comprising the step of:
sending temperature control information from the presenter's computer to a temperature control apparatus.

28. A presentation method as claimed in claim 27, further comprising the step of:
sending audio information from the presenter's computer to an audio system.
